(19) United States
(12) Patent Application Publication
(10) Pub. No.: US 2015/0161109 A1
(43) Pub. Date: Jun. 11, 2015

(54) REORDERING WORDS FOR MACHINE TRANSLATION

(71) Applicants: David TALBOT, San Francisco, CA (US); Graham NEUBIG, Hyogo (JP); Hiroshi ICHIKAWA, Tokyo (JP)

(72) Inventors: David TALBOT, San Francisco, CA (US); Graham NEUBIG, Hyogo (JP); Hiroshi ICHIKAWA, Tokyo (JP)

(73) Assignee: GOOGLE INC., Mountain View, CA (US)

(21) Appl. No.: 13/350,694

(22) Filed: Jan. 13, 2012

(51) Int. Cl. G06F 17/28

(52) U.S. Cl. CPC G06F 17/289

(57) ABSTRACT

Embodiments generally relate to machine translation. In one embodiment, a method includes receiving a sentence of a source language. The method also includes parsing the sentence into words. The method also includes determining scores for the words, where each score is associated with features of each respective word. The method also includes reordering the words based on the scores.

### TECHNICAL FIELD

Embodiments relate generally to machine translation, and more particularly to reordering words for machine translation.

### BACKGROUND

Machine translation uses computer software to translate text or speech from one natural language to another (e.g., from a source language to a target language). Machine translation performs a translation in part by substituting of words in one natural language for words in another natural language. This technique alone might not result in good translations of a text, even when considering grammatical rules, because grammatical rules can be complex. For example, a given language may have unique idioms, grammatical exceptions, and other anomalies. Accordingly, word reordering is a sub-problem in machine translation. To translate between two languages with very different structures (e.g., English and Japanese), it may be necessary to reorder the words of the source language into their target language word order.

### SUMMARY

Embodiments generally relate to machine translation. In one embodiment, a method includes: receiving a sentence of a source language; parsing the sentence into a plurality of words; determining a plurality of scores for words of the plurality of words, where each score is associated with features of each respective word; and reordering the plurality of words based on the plurality of scores.

In one embodiment, the determining of the plurality of scores is based on a parse tree of words of the plurality of words, where the parse tree includes a root node that is associated with a verb of the sentence, and where child nodes of the parse tree are associated with other words of the sentence.

In one embodiment, the determining of the plurality of scores includes: converting a parse tree of words of the plurality of words into pairwise data, where the pairwise data includes different combinations of word pairs from the plurality of words; determining a reordering value for each word pair, where the reordering value indicates whether to reorder the words in the respective word pair; and computing a score for each word of the plurality of words based on the features of each word. In one embodiment, the features of a particular word include one or more of a sentence structure role, a part of speech, and a sentence position in the source language.

In one embodiment, the reordering includes: comparing scores of the words in each pair of words; and reordering each pair of words based on the comparing of the scores. In one embodiment, the reordering includes: comparing scores of the words in each pair of words; and assigning a numerical value to each pair of words based on the reordering. In one embodiment, the reordering includes: ranking the words of the plurality of words based on their scores; and reordering the plurality of words based on the ranking. In one embodiment, the reordering includes: reordering groups of words of the plurality of words, where the reordering of the groups of words is based on a relationship between each parent word within each group of words and a head word of the sentence; and reordering the words within each group of words. In one embodiment, the reordering includes: reordering groups of words of the plurality of words; and reordering the words within each group of words. In one embodiment, the method also includes translating each of the words from the source language to a target language.

In another embodiment, a method includes: receiving a sentence of a source language; parsing the sentence into a plurality of words; determining a plurality of scores for words of the plurality of words, where each score is associated with features of each respective word. In one embodiment, the determining of the plurality of scores includes: converting a parse tree of words of the plurality of words into pairwise data, where the pairwise data includes different combinations of word pairs from the plurality of words; determining a reordering value for each word pair, where the reordering value indicates whether to reorder the words in the respective word pair; and computing a score for each word of the plurality of words based on the features of each word; and where the features of a particular word include one or more of a sentence structure role, a part of speech, and a sentence position in the source language.

In one embodiment, the method further includes: reordering the plurality of words based on the plurality of scores, where the reordering includes ranking the words of the plurality of words based on their scores and reordering the plurality of words based on the ranking; and translating each of the words from the source language to a target language.

In another embodiment, a system includes: one or more processors; and logic encoded in one or more tangible media for execution by the one or more processors and when executed operable to perform operations including: receiving a sentence of a source language; parsing the sentence into a plurality of words; determining a plurality of scores for words of the plurality of words, where each score is associated with features of each respective word; and reordering the plurality of words based on the plurality of scores.

In one embodiment, the determining of the plurality of scores is based on a parse tree of words of the plurality of words, where the parse tree includes a root node that is associated with a verb of the sentence, and where child nodes of the parse tree are associated with other words of the sentence. In one embodiment, the logic when executed is further operable to perform operations including: converting a parse tree of words of the plurality of words into pairwise data, where the pairwise data includes different combinations of word pairs from the plurality of words; determining a reordering value for each word pair, where the reordering value indicates whether to reorder of the words in the respective word pair; and computing a score for each word of the plurality of words based on the features of each word.

In one embodiment, the features of a particular word include one or more of a sentence structure role, a part of speech, and a sentence position in the source language. In one embodiment, the logic when executed is further operable to perform operations including: comparing scores of the words in each pair of words; and reordering each pair of words based on the comparing of the scores. In one embodiment, the logic when executed is further operable to perform operations including: comparing scores of the words in each pair of words; and assigning a numerical value to each pair of words based on the reordering. In one embodiment, the logic when executed is further operable to perform operations including: ranking the words of the plurality of words based on their scores; and reordering the plurality of words based on the ranking. In one embodiment, the logic when executed is further operable to perform operations including: reordering groups of words of the plurality of words; and reordering the words within each group of words. In one embodiment, the logic when executed is further operable to translate each of the words from the source language to a target language.

### BRIEF DESCRIPTION OF THE DRAWINGS

FIG. 1 illustrates a block diagram of an example system, which may be used to implement the embodiments described herein.

FIG. 2 illustrates an example simplified flow diagram for reordering words for machine translation, according to one embodiment.

FIG. 3 illustrates an example parse tree containing the words from a source language, according to one embodiment.

FIG. 4 illustrates an example table that includes words, features, positions, and labels, according to one embodiment.

FIG. 5 illustrates an example simplified flow diagram for generating scores, according to one embodiment.

FIG. 6 illustrates an example table that includes pairwise data, scores, and a reordering value, according to one embodiment.

FIG. 7 illustrates an example table that includes scores, according to one embodiment.

FIG. 8 illustrates a block diagram of an example server device, which may be used to implement the embodiments described herein.

### DETAILED DESCRIPTION

Embodiments described herein improve reordering words for machine translation. For example, in one embodiment, a system receives a sentence (e.g., He ate lunch.) of a natural source language (e.g., English). The system parses the sentence into words (e.g., he, ate, lunch). The system then determines scores for the words, where each score is associated with features of each respective word. For example, features of a particular word may include its sentence structure role or function, its part of speech, and its sentence position in the source language. The system then reorders the words into a word order of a natural target language (e.g., Japanese) based on the scores (e.g., he, lunch, ate). The system may then translate each word from the source language to the target language.

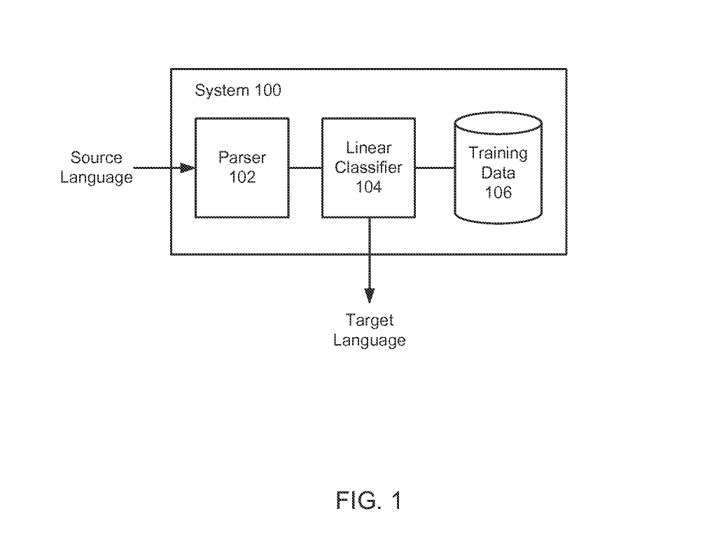

FIG. 1 illustrates a block diagram of an example system 100, which may be used to implement the embodiments described herein. In one embodiment, system 100 includes a parser 102, a linear classifier 104, and a database 106 that stores training data. In other embodiments, system 100 may not have all of the components shown and/or may have other elements including other types of elements instead of, or in addition to, those shown herein, as described in more detail below.

While system 100 is described as performing the steps as described in the embodiments herein, any suitable component or combination of components of system 100 or any suitable processor or processors associated with system 100 may perform the steps described. For example, in various embodiments described herein, parser 102 may parse sentences, and linear classifier 104 may perform operations to reorder words of a source language sentence into a word order of a target language for machine translation.

Embodiments described herein are directed to reordering a sentence of a source language into a word order of a target language in a machine translation process. In the following example embodiments, the source language is English and the target language is Japanese.

The following flow diagram describes a method that is performed during testing time or translation time (e.g., in real-time).

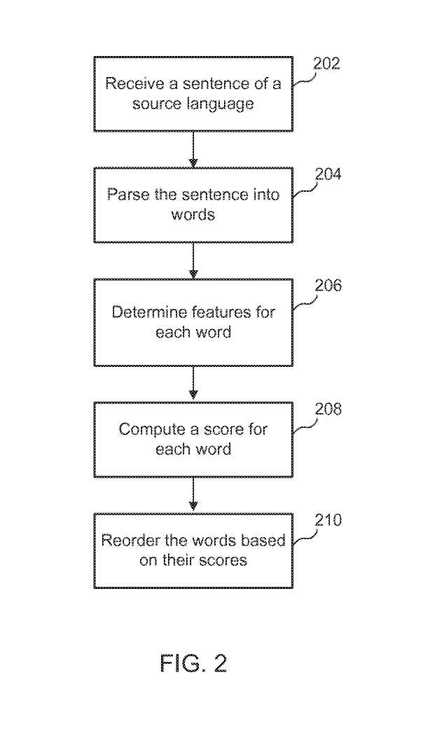

FIG. 2 illustrates an example simplified flow diagram for reordering words for machine translation, according to one embodiment. Referring to both FIGS. 1 and 2, the method is initiated in block 202, where system 100 receives a sentence of a source language. In the following example, the sentence of the source language is English, as indicated above, and the sentence is: “He ate lunch.” For ease of illustration, a simple three-word sentence is used in these examples. Embodiments described herein may also apply to other sentences having any number of words, sentences having higher complexity, and sentences having multiple phrases. Examples illustrating some variations are also described below.

In block 204, system 100 parses the sentence into words. In this example, the words are “he,” “ate,” and “lunch.” In one embodiment, system 100 generates a parse tree.

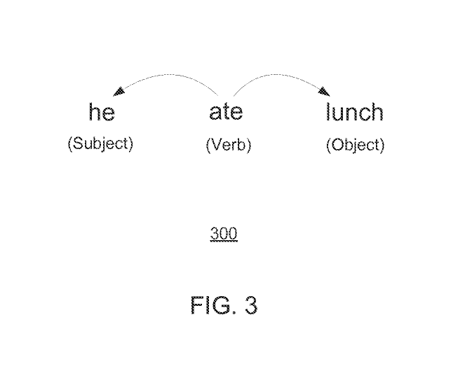

FIG. 3 illustrates an example parse tree 300 containing the words from the source language (e.g., “he,” “ate,” and “lunch”). Also shown is sentence structure information. For example, “he” is a subject, “ate” is a verb, and “lunch” is an object. Also shown are nodal relationships among the words (indicated by arrows). For example, in one embodiment, the verb is associated with the root node or parent node, and the subject and object are associated with child nodes. The verb may be referred to as the head word, the head of the sentence, or the source head. In various embodiments, the reordering of the sentence is relative to the head word.

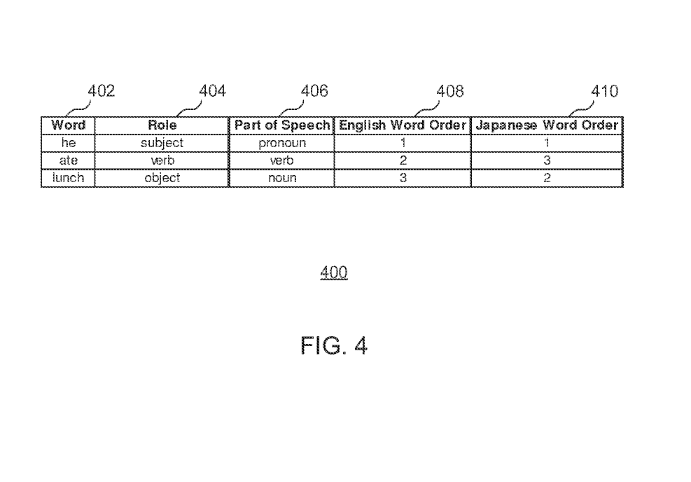

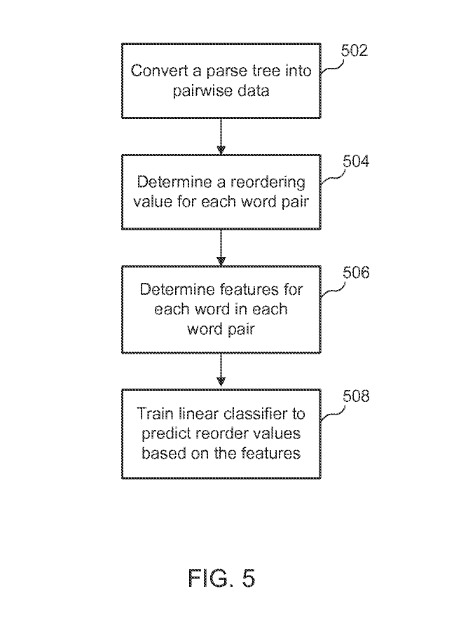

Referring again to FIG. 2, in block 206, system 100 determines or extracts features for each word of the sentence, which are described in more detail below in connection with FIGS. 4 and 5.

In block 208, system 100 computes a score for each word, where each score is associated with features of each respective word. As described in more detail below, features of a particular word include characteristics that may include, for example, its sentence structure role or function, its part of speech, its sentence position in the source language, etc. Note the phrase “sentence structure role” may be used interchangeably with the phrase “syntactic role.”

In one embodiment, the score may be computed for each word in the sentence using the following equation: score=sum_i weight_i*feature_i(word), where each feature is multiplied by a weight.

In general, in one embodiment, the weights may be negative for features that are frequently observed with words that are reordered in the training data. Due to interactions among features, this is not necessarily always the case.

At test time or translation time, system 100 generates features for each word and computes the weighted sum of these features, where the weights were learned from training data. As described in more detail below, system 100 may then rank the words according to these weighted sums (scores). In various embodiments, this would result in the same ranking that would result by comparing pairs of words in turn and reordering if: sign(sum_i weight_i*(feature_i(word_{—}1)−feature_i(word_{—}2)) is negative.

In block 210, system 100 reorders the words of the source sentence into a word order of the target language based on the scores. In one embodiment, system 100 ranks the words by their scores based on their scores and then reorders the words based on their rankings. In one embodiment, words having higher scores come before words having lower scores in the sentence (e.g., in descending order). For example, if “he” has a score of 0.163, “ate” has a score of 0.127, and “lunch” has a score of 0.147, their relative ranking would be: “he” (0.163), “lunch” (0.147), “ate” (0.127). Accordingly, the resulting word order in the target language would be: he lunch ate, which is a successful subject-verb-object (SVO) to subject-object-verb (SOV) translation. Alternatively, in other embodiments, words having lower scores may come before words having higher scores in the sentence (e.g., in ascending order), and the particular reordering will depend on the particular implementation.

In one embodiment, after the words are reordered into the word order of the target language (e.g., Japanese), system 100 may then translate each of the words from the source language to the target language (e.g., from English to Japanese).

In one embodiment, the method of flow diagram of FIG. 2, described above, is performed during translation time (e.g., in real-time). In one embodiment, system 100 determines the scores for the reordering by obtaining the scores (e.g., stored in database 104), which are predetermined during a training time (e.g., independent of translation time). Example embodiments for providing scores are described in detail below in connection with FIGS. 4 and 5.

FIG. 4 illustrates an example table 400 that includes words, features, positions, and labels, according to one embodiment. As shown, table 400 includes a column 402 that includes words (e.g., “he,” “ate,” and “lunch”) from parse tree 300. Table 400 also includes a column 404 that includes respective sentence structure roles (e.g., “subject,” “verb,” and “object”). Table 400 also includes a column 406 that includes respective parts of speech (e.g., “pronoun,” “verb,” and “noun”). Table 400 also includes a column 408 that includes respective sentence positions in the source language (e.g., “1,” “2,” and “3”).

Table 400 also includes a column 410 that includes respective sentence positions in the target language (e.g., “1,” “3,” and “2”), also referred to as a “labels.” In one embodiment, the sentence positions in the target language may be based on input from annotators, where annotators are fluent in both the source language and the target language. One or more annotators may reorder many (e.g., hundreds or thousands) of reference sentences and reference phrases, such that the correct reorderings are determined and annotated by the annotators.

For ease of illustration, the example features described above include sentence structure role, its part of speech, and sentence position in the source language. Other embodiments might not have all of these features described, and/or may have other features instead of, or in addition to, these described. For example, other embodiments may include relative position to one or more other words in the source and/or sentence, and relative position to one or more punctuation marks, etc. In one embodiment, system 100 may also determine features based on the parse tree. For example, a feature may include the relative distance of a word to the head word.

The following flow diagram describes a method that is performed during learning/training time (e.g., independent of translation time).

FIG. 5 illustrates an example simplified flow diagram for generating scores, according to one embodiment. Referring to both FIGS. 1 and 5, the method is initiated in block 502, where system 100 converts a parse tree of words into pairwise data.

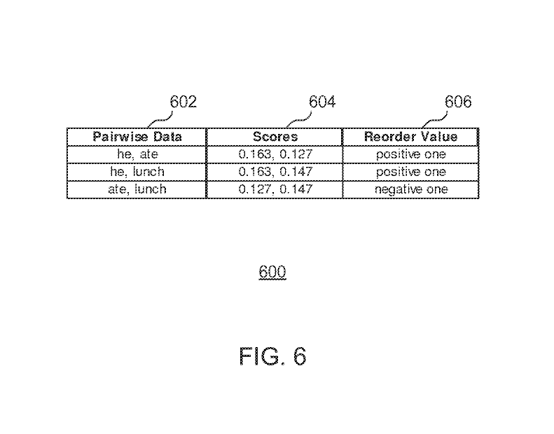

FIG. 6 illustrates an example table 600 that includes pairwise data, scores, and a reordering value, according to one embodiment. As shown, table 600 includes a column 602 that includes pairwise data (e.g., “he, ate” “he, lunch,” and “ate, lunch”), which includes different combinations of word pairs from the parse tree. Table 600 also includes a column 604 that includes corresponding scores (e.g., “0.163, 0.127,” “0.163, 0.147,” and “0.127, 0.147”). With regard to the scores, in one embodiment, the scores may be derived from the features of each word, which are described in more detail below.

Referring again to FIG. 5, in block 504, system 100 determines a reordering value for each word pair, where the reordering value indicates whether to reorder the words in the respective word pair. In one embodiment, system 100 may assign to each pair of words a numerical value for the reordering value based on the reordering. For example, as FIG. 6 shows, in one embodiment, “+1” indicates that the word order remains the same (e.g., “he” comes before “ate”). In one embodiment, “−1” indicates that the word order changes (e.g., “lunch” comes before “ate”). In other embodiments, the reordering value is not limited to numeric values as indicators. For example, words such as “do not change word order” may be used instead of “+1,” and words such as “change word order” may be used instead of “−1.” Other indicators are possible.

In one embodiment, the determining of a reordering value for each word pair is performed during training. For example, during training time, system 100 looks at word aligned training data to determine the target order. System 100 then extracts pairs of words with features from the parse tree and provides them as training examples to the linear classifier with a label (e.g., “+1” or “−1”), depending on whether the target order of the given pair is the same or the reverse of the corresponding source words.

In block 506, system 100 determines or extracts features for each word in each word pair based on the features of the words. In one embodiment, for each word, system 100 may run through a list of features and determine if the word has each feature. For example, in one embodiment, system 100 may determine if a given word is a “verb.” If yes, system 100 may assign a “1” for that feature. If no, system 100 may assign a “0” for that feature. System 100 may perform this same process for many different features related to sentence structure role, part of speech, sentence position in the source language, etc.

In block 508, system 100 trains linear classifier 104 to predict reorder values based on the features of the words. In one embodiment, linear classifier 104 learns one weight for each feature. In one embodiment, linear classifier 104 determines weights such that (i indexes the features) and according to the following equation: sign(sum_i weight_i*(feature_i(word_{—}1)−feature_i(word_{—}2)), where the result is >0 for words that should stay in order and <0 for words that should be reversed. Stated differently, if the first word has a greater score than that of the second word, where the result is >0, their word order remains the same. If the first word has a lower score than that of the second word, where the result is <0, their word order reverses. In alternative embodiments, the equation may be modified such that the reverse is true, where the result is <0 for words that should stay in order and >0 for words that should be reversed.

In one embodiment, system 100 may compare the scores of the words in each pair of words, and then determine the word order of the words in each pair of words based on the comparison of the scores. Table 600 also includes a column 606 that includes reorder values (e.g., “+1,” “−1”).

In one embodiment, system 100 may also reorder groups of words, and then reorder the words within each group of words. Stated differently, system 100 recursively works its way down a parse tree into subtrees in order to perform the reordering for the entire sentence. For example, if the sentence of the source language is “He ate a big lunch,” system 100 may group the words “a big lunch” together (into a subtree) and move the group together (with descendents, if any) during a reordering. For example, the resulting order may be: he a big lunch ate. System 100 may then reorder the group of words “a big lunch” within the subtree, if appropriate. In this particular example, the resulting order would be: he a big lunch ate. In one embodiment, the reordering of the groups of words is based on a relationship between each word within each group and a head word of the sentence.

In one embodiment, the features included in table 400 and the labels for the word order in the target language may be referred to as a feature vector f. In one embodiment, scores for words may be modified and fine tuned over time (e.g., during training times) in order to better predict sentences that do not exactly match any reference sentences or reference phrases. In one embodiment, scores are influenced by the features of the words. In one embodiment, system 100 may weigh different features differently by multiplying each feature vector f by a weight vector w. As such, each weight vector influences how much each feature affects a particular score, which in turn influences the resulting word order. For example, features that are less useful in predicting correct word order may be given a lower weight in order to decrease their influence on the resulting word order. In one embodiment, system 100 may even remove less useful features from consideration. Conversely, features that are more useful in predicting correct word order may be given a higher score in order to increase their influence on the resulting word order. For example, the part of speech would be useful in predicting correct word order and would thus be associated with a higher weight.

In various embodiments system 100 continuously collects data associated with the features and weighs them for their usefulness in predicting proper word reordering.

As such, embodiments described herein enable system 100 to improve its ability to reorder different combinations of words that do not exactly match reference sentences or reference phrases from the source language to the target language.

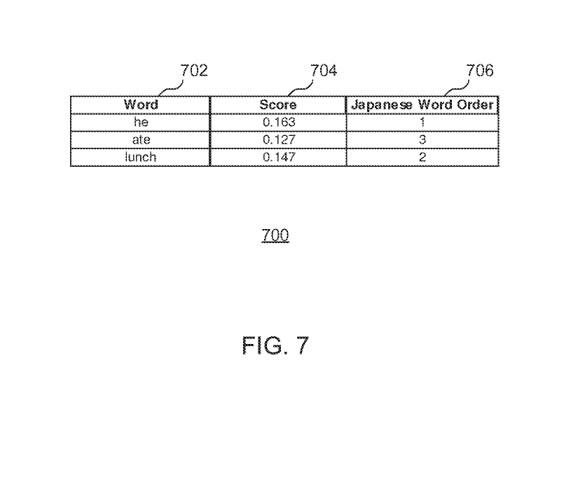

FIG. 7 illustrates an example table 700 that includes scores, according to one embodiment. As shown, table 700 includes a column 702 that includes words from a parse tree (e.g., “he,” “ate,” “lunch”). Table 700 also includes a column 704 that includes corresponding scores (e.g., “0.163,” “0.127,” and “0.147”). Table 700 also includes a column 706 that includes corresponding word positions (e.g., “1,” “3,” “2”), which are based on the relative ranking of the scores. Accordingly, the resulting word order in the target language would be: he lunch ate.

A result of the embodiments described herein is that scores tend to push words either toward the front of the sentence when reordered or toward the end of the sentence when reordered, depending on the particular implementation. Examples herein are described such that words with higher scores are pushed toward the front of the sentence, where the word with the highest score is at the front of the sentence after reordering, and vice versa. In other embodiments, words with higher scores may be pushed toward the end of the sentence, where the word with the highest score is at the end of the sentence after reordering, and vice versa.

Although the steps, operations, or computations may be presented in a specific order, the reorder may be changed in particular embodiments. Other orderings of the steps are possible, depending on the particular implementation. In some particular embodiments, multiple steps shown as sequential in this specification may be performed at the same time.

While example embodiments herein are described in the context of English to Japanese, other embodiments may be applied in the reverse, from Japanese to English. Also, other embodiments may be applied to any combination of languages (e.g., English to Russian and vice versa, Spanish to Hindi and vice versa, etc.).

Embodiments described herein provide various benefits. For example, embodiments described herein also increase the overall performance of the machine translation system. Embodiments also improve predictions and ultimate reordering of words for machine translation.

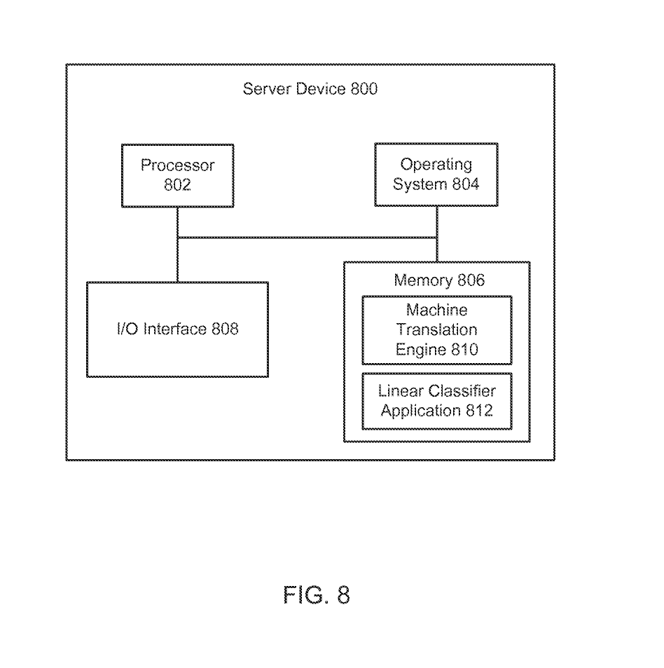

FIG. 8 illustrates a block diagram of an example server device 800, which may be used to implement the embodiments described herein. For example, server device 800 may be used to implement system 100 of FIG. 1, as well as to perform the method embodiments described herein. In one embodiment, server device 800 includes a processor 802, an operating system 804, a memory 806, and an input/output (I/O) interface 808. Server device 800 also includes a machine translation engine 810 and a linear classifier application 812, which may be stored in memory 806 or on any other suitable storage location or computer-readable medium. Linear classifier application 812 provides instructions that enable processor 802 to perform the functions described herein and other functions.

For ease of illustration, FIG. 8 shows one block for each of processor 802, operating system 804, memory 806, I/O interface 808, social network engine 810, and media application 812. These blocks 802, 804, 806, 808, 810, and 812 may represent multiple processors, operating systems, memories, I/O interfaces, machine translation engines, and linear classifier applications. In other embodiments, server device 800 may not have all of the components shown and/or may have other elements including other types of elements instead of, or in addition to, those shown herein.

Although the description has been described with respect to particular embodiments thereof, these particular embodiments are merely illustrative, and not restrictive. Concepts illustrated in the examples may be applied to other examples and embodiments.

Note that the functional blocks, methods, devices, and systems described in the present disclosure may be integrated or divided into different combinations of systems, devices, and functional blocks as would be known to those skilled in the art.

Any suitable programming languages and programming techniques may be used to implement the routines of particular embodiments. Different programming techniques may be employed such as procedural or object-oriented. The routines may execute on a single processing device or multiple processors. Although the steps, operations, or computations may be presented in a specific reorder, the reorder may be changed in different particular embodiments. In some particular embodiments, multiple steps shown as sequential in this specification may be performed at the same time.

A “processor” includes any suitable hardware and/or software system, mechanism or component that processes data, signals or other information. A processor may include a system with a general-purpose central processing unit, multiple processing units, dedicated circuitry for achieving functionality, or other systems. Processing need not be limited to a geographic location, or have temporal limitations. For example, a processor may perform its functions in “real-time,” “offline,” in a “batch mode,” etc. Portions of processing may be performed at different times and at different locations, by different (or the same) processing systems. A computer may be any processor in communication with a memory. The memory may be any suitable processor-readable storage medium, such as random-access memory (RAM), read-only memory (ROM), magnetic or optical disk, or other tangible media suitable for storing instructions for execution by the processor.

1.-20. (canceled)

21. A computer-implemented method, comprising:
receiving, at a computing system having one or more processors, a sentence in a source language;
parsing, at the computing system, the sentence into a plurality of words;
determining, at the computing system, a score for each particular word of the plurality of words based on features of the particular word, the features including at least one of syntactic role, part of speech, and position within the sentence, wherein each score is indicative of a degree of likelihood of its corresponding word being a next word in a translated sentence corresponding to a translation of the sentence from the source language to a target language;
determining, at the computing system, pairwise data from the plurality of words, each particular word pair of the pairwise data including a different combination of words from the plurality of words;
determining, at the computing system, a reordering value for each particular word pair of the pairwise data based on the scores of words in the particular word pair, each reordering value being indicative of whether to reorder the words in the particular word pair;
reordering, at the computing system, the plurality of words in the sentence based on the reordering values to obtain a reordered sentence; and
obtaining, at the computing system, a translation of the sentence into a target language based on the reordered sentence.

22. A computer-implemented method, comprising:
receiving, at a computing system having one or more processors, a sentence in a source language;
parsing, at the computing system, the sentence into a plurality of words;
determining, at the computing system, a score for each particular word of the plurality of words based on a plurality of features of the particular word, the plurality of features including at least one of syntactic role, part of speech, and sentence position, wherein each score is indicative of a degree of likelihood of its corresponding word being a next word in a translated sentence corresponding to a translation of the sentence from the source language to a target language; and
reordering, at the computing system, the plurality of words based on the scores.

23. The computer-implemented method of claim 22, wherein determining the score for each word of the plurality of words comprises:
determining a sub-score corresponding to each feature of the plurality of features for each particular word; and
combining the sub-scores to obtain the score for each particular word.

24. The computer-implemented method of claim 23, wherein combining the sub-scores to obtain the score for each particular word comprises:
obtaining a weight corresponding to each feature of the plurality of features;
multiplying each sub-score by the weight corresponding to the particular feature to which the sub-score corresponds to obtain a weighted sub-score; and
summing the weighted sub-scores.

25. The computer-implemented method of claim 22, wherein determining the score for each word of the plurality of words is based on a parse tree of words of the plurality of words, wherein the parse tree includes a root node that is associated with a verb of the sentence, and wherein child nodes of the parse tree are associated with other words of the sentence.

26. The computer-implemented method of claim 22, wherein reordering the plurality of words based on the scores comprises:
determining one or more pairs of words;
comparing scores of the words in each of the one or more pairs of words; and
reordering the words in each of the one or more pairs of words based on the comparing of the scores.

27. The computer-implemented method of claim 26, wherein reordering the plurality of words based on the scores further comprises assigning a numerical value to each pair of the one or more pairs of words based on the reordering.

28. The computer-implemented method of claim 22, wherein reordering the plurality of words based on the scores comprises:
ranking the words of the plurality of words based on the scores; and
reordering the plurality of words based on the ranking.

29. (canceled)

30. The computer-implemented method of claim 22, wherein determining the score for each particular word comprises obtaining scores from a database that includes predetermined scores learned from training data.

31. The computer-implemented method of claim 22, further comprising:
obtaining a reordered sentence based on the reordering of the plurality of words; and
translating the sentence from the source language to a target language by translating each of the words in the reordered sentence from the source language to the target language.

32. A system comprising:
one or more processors; and
logic encoded in one or more non-transitory computer-readable media for execution by the one or more processors and when executed operable to perform operations comprising:
receiving a sentence in a source language;
parsing the sentence into a plurality of words;
determining a score for each particular word of the plurality of words based on a plurality of features of the particular word, the plurality of features including at least one of syntactic role, part of speech, and sentence position, wherein each score is indicative of a degree of likelihood of its corresponding word being a next word in a translated sentence corresponding to a translation of the sentence from the source language to a target language; and
reordering the plurality of words based on the scores.

33. The computer system of claim 32, wherein determining the score for each word of the plurality of words comprises:
determining a sub-score corresponding to each feature of the plurality of features for each particular word; and
combining the sub-scores to obtain the score for each particular word.

34. The computer system of claim 32, wherein combining the sub-scores to obtain the score for each particular word comprises:
obtaining a weight corresponding to each feature of the plurality of features;
multiplying each sub-score by the weight corresponding to the particular feature to which the sub-score corresponds to obtain a weighted sub-score; and
summing the weighted sub-scores.

35. The computer system of claim 32, wherein determining the score for each word of the plurality of words is based on a parse tree of words of the plurality of words, wherein the parse tree includes a root node that is associated with a verb of the sentence, and wherein child nodes of the parse tree are associated with other words of the sentence.

36. The computer system of claim 32, wherein reordering the plurality of words based on the scores comprises:
determining one or more pairs of words;
comparing scores of the words in each of the one or more pairs of words; and
reordering the words in each of the one or more pairs of words based on the comparing of the scores.

37. The computer system of claim 32, wherein reordering the plurality of words based on the scores comprises:
ranking the words of the plurality of words based on the scores; and
reordering the plurality of words based on the ranking.

38. (canceled)

39. The computer system of claim 32, wherein determining the score for each particular word comprises obtaining scores from a database that includes predetermined scores learned from training data.

40. The computer system of claim 32, wherein the operations further comprise:
obtaining a reordered sentence based on the reordering of the plurality of words; and
translating the sentence from the source language to a target language by translating each of the words in the reordered sentence from the source language to the target language.
